(19) United States
(12) Patent Application Publication
(10) Pub. No.: US 2008/0059206 A1
(43) Pub. Date: Mar. 6, 2008

(54) Method of distributing the cost of preserving the environment

(76) Inventor: Federico Jenkins, Ecoresidencial Villareal (CR)

Correspondence Address: ADORNO & YOSS, LLP, 1233 20th Street, NW, SUITE 703, WASHINGTON, DC, 20036, US

(21) Appl. No.: 11/451,598

(22) Filed: Jun. 13, 2006

Related U.S. Application Data
(60) Provisional application No. 60/781,756, filed on Mar. 14, 2006.

(51) Int. Cl. G06Q 99/00

(52) U.S. Cl. 705/1

(57) ABSTRACT

A method of distributing the cost of preserving the environment is disclosed. The method allows individuals to directly participate in the cost of preserving the environment or be directly penalized in accordance with their choices that adversely affect the environment. Thus, everyone is provided an opportunity to actively participate in the cost for preserving the environment in every way that the environment is adversely effected.

### REFERENCE TO RELATED APPLICATION

This application claims priority to provisional patent application Ser. No. 60/781,756 filed on Mar. 14, 2006 and entitled “Subscription Based Method for Preservation of the Environment. ”

### BACKGROUND OF THE INVENTION

The present application is generally related to the field of environmental protection and safety and more particularly, is directed to a method of distributing the cost of preserving the environment among those who cause it harm. The invention provides a way for individuals to directly participate in the cost of preserving the environment or be directly penalized in accordance with their choices that adversely effect the environment.

Deterioration of the environment is a problem of great concern to many people. The adverse effects of global warming, the health hazards caused by pollution and poor air quality associated with the burning of fossil fuels, and the decreasing numbers of truly pristine habitats around the world are but a few of the environmental concerns that presently confront society.

Society and governments recognize the problem and seek to address its causes in different ways. For example, the creation of various government agencies, such as the Environmental Protection Agency in the United States, international agreements and understandings, such as the Kyoto Accord on global warming, and a greater awareness of the problem and its consequences among the general public have been beneficial in reducing the rate of deterioration of the environment.

Concern for the environment has lead to, for example, the creation of alternative fuel sources for powering automobiles, intelligent use of energy sources through more efficient machines and a greater sense of urgency on the part of consumers. While these efforts have had a positive effect on the environment, the continued growth in industrialized nations and the rapid rate of growth in some lesser developed nations have caused the environment to continue to deteriorate, although at a slower rate.

In most cases, the consumer is relegated to a minor role when it comes to protecting the environment or sharing directly in the cost of its preservation. While a consumer can purchase a more fuel efficient automobile, or perhaps even a hybrid, the effect is rather insignificant when compared to the substantial number of older and less fuel efficient automobiles that remain in service. Moreover, the purchase of a more fuel efficient automobile may in fact be the only way that a consumer can truly participate in the cost of preserving the environment.

The converse also is true that consumers are not personally penalized for the harm caused to the environment by their choices in buying less fuel efficient vehicles, for example, or engaging in other behavior that has an adverse effect on the environment. Society at large suffers as a result.

### SUMMARY OF THE INVENTION

For the foregoing reasons, there is a need in the art for a way of promoting the preservation of the environment in a way in which everyone can participate.

It is therefore, a primary objective of the present invention to provide a method of preserving the environment that allows individuals to directly participate in the cost of preservation or be directly penalized in accordance with their choices that adversely effect the environment.

It is a further objective of the present invention to provide a method of preserving the environment that spreads the burden of preservation among those who are responsible for its deterioration.

It is a still further objective of the present invention to provide a method of preserving the environment that is easy to implement and to maintain.

It is a further objective of the present invention to provide a method of preserving the environment that is low in cost to implement and to maintain.

It is another objective of the present invention to provide a method of preserving the environment that can be adopted by government regulatory agencies and enforced.

It is a still further objective of the present invention to provide a method of preserving the environment that can be adopted by commercial enterprises as a part of their business activities.

It is another objective of the present invention to provide a method of preserving the environment that can be used across international borders.

It is another objective of the present invention to provide a method of preserving the environment that can be shared across a wide spectrum of those who have a negative effect on the environment.

The present invention provides everyone the opportunity to actively participate in the cost for preserving the environment in every way that the environment is adversely effected. The invention also permits a consumer to be made directly responsible for, and to pay for, the harm caused to the environment by the individual choices that the consumer makes.

### BRIEF DESCRIPTION OF THE DRAWINGS

These and other features, aspects, objectives, and advantages of the present invention will become better understood upon consideration of the following detailed description, appended claims and accompanying drawing where:

FIG. 1 is block diagram illustrating one embodiment of the present invention with respect to an automobile.

It should be understood that the drawing are not necessarily to scale and that the embodiment are sometimes illustrated by graphic symbols, phantom lines, diagrammatic representations and fragmentary views. In certain instances, details which are not necessary for an understanding of the present invention or which render other details difficult to perceive may have been omitted. It should also be understood, of course, that the invention is not necessarily limited to the particular embodiments illustrated herein.

### DESCRIPTION OF THE PREFERRED EMBODIMENT

A description of the preferred embodiment of the invention will now be described.

It is well known that virtually every activity of man has an effect on the environment. Most of these activities have a negative effect and can be quantified in some manner. For example, it is known in the art that during the combustion process, a gasoline engine produces and emits to the atmosphere a number of volatile organic compounds. These emissions include oxides of nitrogen, particulate matter and carbon dioxide.

These emissions are measurable and in the case of an automobile, can be correlated to driving patterns and distances driven with respect to a particular automobile. It is known in the art, for example, that the typical gasoline powered compact automobile emits about 4 tons of carbon dioxide into the atmosphere annually based upon an average driving distance of approximately 15,000 miles per year.

On the other hand, trees and other plants have a positive effect on the environment. Trees make their own food from carbon dioxide and in the process, release oxygen back into the atmosphere. A half acre of trees will absorb approximately 4 tons of carbon dioxide annually, i.e., the yearly amount emitted into the atmosphere by the above mentioned compact automobile. Thus, the amount of carbon dioxide absorbed by a half acre of trees will offset the amount emitted into the atmosphere by an automobile. Accordingly, the automobile will have a neutral effect on the environment.

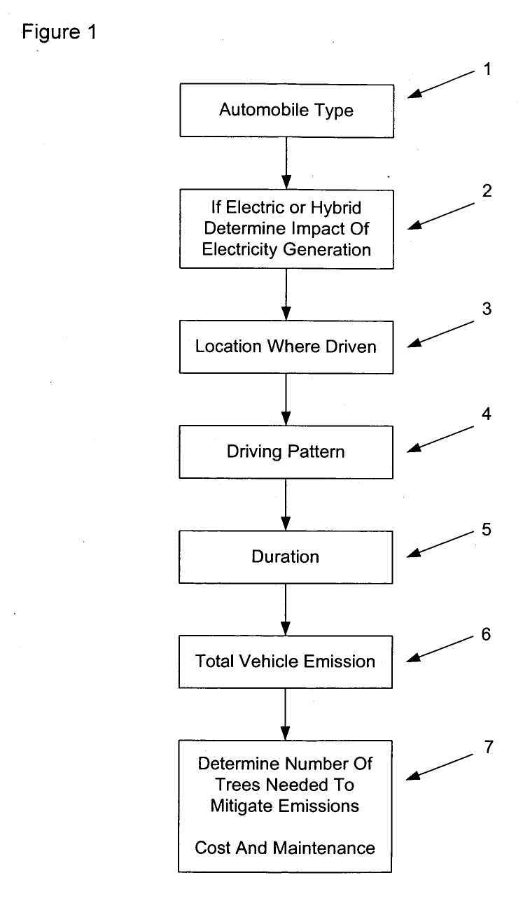

FIG. 1 is a block diagram illustrating the factors to be considered in determining the total amount of carbon dioxide emitted into the atmosphere by an automobile.

In block 1, the type of automobile is determined with respect to size, and estimated miles-per-gallon. Other factors with respect to type of automobile include whether it is propelled by gasoline, diesel fuel, LP gas or is electric or a hybrid. As illustrated in block 2, if the automobile is electric, a determination is made with respect to the amount of carbon dioxide emitted into the atmosphere from the generation of the electricity required to operate the automobile. In block 3, the location where the automobile is going to be driven is determined. In block 4, expected driving patterns of the user are determined. Driving patterns include, expected number of miles to be driven, percent in city/highway, etc. In block 5, driving duration is determined.

Using the determinations made in blocks 1-5, the total carbon dioxide emitted by the automobile can be calculated as illustrated in block 6. Once this calculation is made, the number of trees needed to absorb or mitigate the emissions can be determined as shown in block 7, along with the full cost of their planting and maintenance. At this point a number of scenarios are available.

The particular entity that it promoting a preservation of the environment program, such as a government agency or private group, can then issue a so-called total emission free certificate for the particular vehicle. By subscribing to such a program and paying for the certificate, the consumer can participate in the true cost of the adverse effects on the environment caused by the automobile. The certificate can be fully paid upfront or amortized over the period of a lease or loan.

The preservation program may also allow the consumer to choose the location where trees are to be planted, such as a rainforest, replanted forest and the like.

The above described concept can be extended to virtually every type of device or activity that has a detrimental effect on the environment. For example, a hotel can determine the impact on the environment caused by its operations on a per-room basis and pass that cost on to the guest. Restaurants can do a similar thing with respect to the impact on the environment due to food preparation. Thus, every consumer can fully participate in the cost of preserving the environment.

It should also be noted that the amount of carbon dioxide that a device emits into the atmosphere will depend on the specific design and operation of the device. For example, many automobiles emit as much as 7 tons of carbon dioxide into the atmosphere annually. Mitigation of the harmful effects of the emissions can be achieved in a number of ways, including the planting of trees, forest conservation and/or the designation of certain areas specifically for carbon sequestration in order to offset the emissions. So-called carbon certificates can be used to certify such areas for such purpose. This same approach can be used to certify, and give environmental credit for, alternative sources of energy that are cleaner to the environment and serve to offset the adverse effects on the environment caused by less environmentally friendly devices. In addition, the cost of mitigating the harmful effects on the environment can be absorbed by the manufacturers of the devices that cause the harm, those who sell such devices, end users of such devices or a combination of all three. The concept can be applied to airline tickets, car rentals, hotel rooms, restaurants and any other transaction or activity in the world that causes harm to the environment through carbon dioxide emissions.

Although the present invention has been described in considerable detail with reference to certain preferred embodiments, one skilled in the art will appreciate that the present invention can be practiced by other than the preferred embodiments, which have been presented for purposes of illustration and not of limitation. Therefore, the spirit and scope of the appended claims should not be limited to the description of the preferred embodiments contained herein.

I claim:

1. A method of distributing the cost of preserving the environment, said method comprising the steps of:
determining the adverse impact on the environment caused by a predetermined activity;
determining the cost of mitigating the impact on the environment caused by said activity; and
apportioning said cost of said mitigation to the entity responsible for said activity.

2. A method of distributing the cost of preserving the environment according to claim 1, further including the step of determining a manner in which said impact can be mitigated.

3. A method of distributing the cost of preserving the environment according to claim 2, further including the step of determining a mitigation manner in which said impact can be mitigated.

4. A method of distributing the cost of preserving the environment according to claim 3, wherein said mitigation manner includes the planting of plants.

5. A method of distributing the cost of preserving the environment according to claim 3, wherein said mitigation manner includes the planting of trees.

6. A method of distributing the cost of preserving the environment according to claim 3, wherein said mitigation manner is determined by said entity.

7. A method of distributing the cost of preserving the environment according to claim 5, wherein the location of said trees is determined by said entity.

8. A method of distributing the cost of preserving the environment according to claim 1, wherein said predetermine activity is the operation of a gasoline engine.

9. A method of distributing the cost of preserving the environment according to claim 1, wherein said predetermine activity is the operation of a motor vehicle.

10. A method of distributing the cost of preserving the environment according to claim 1, wherein said predetermine activity is the generation of electricity.

11. A method of distributing the cost of preserving the environment according to claim 1, wherein said predetermine activity is the burning of fossil fuels.

12. A method of distributing the cost of preserving the environment according to claim 1, wherein said predetermine activity is the operation of a motor vehicle.
